(19) United States
(12) Patent Application Publication
(10) Pub. No.: US 2006/0165743 A1
(43) Pub. Date: Jul. 27, 2006

(54) Method and device to control and condition the behavior of the varroa destructor mite in a beehive, or in other environment where bees reproduce

(75) Inventors: Norberto Milani, Udine (IT); Francesco Nazzi, Udine (IT); Giorgio Della Vedova, Grado (IT)

Correspondence Address: STEVENS DAVIS MILLER & MOSHER, LLP, 1615 L STREET, NW, SUITE 850, WASHINGTON, DC, 20036, US

(73) Assignee: Universita' Degli Studi Di Udine, Udine (IT)

(21) Appl. No.: 10/536,441

(22) PCT Filed: Nov. 25, 2003
(86) PCT No.: PCT/IB03/05393

§ 371 Date: May 25, 2005

(30) Foreign Application Priority Data
Nov. 26, 2002 (IT) UD2002A000247

(51) Int. Cl. A01N 37/00

(52) U.S. Cl. 424/405; 514/557

(57) ABSTRACT

Method and device to control and condition the behavior of the Varroa destructor mite in a beehive, or in another environment where bees reproduce. The method comprises a step of applying, in the beehive or in the aforesaid environment, a chemical composition including at least one of the following substances: (+)-2-hydroxyhexanoic acid, (−)-2-hydroxyhexanoic acid, (+)-3-hydroxyhexanoic acid, (−)-3-hydroxyhexanoic acid, or a mixture thereof.

### FIELD OF THE INVENTION

The present invention concerns a method and device to control and condition the behavior of the Varroa destructor mite in a beehive, or in artificial means associated with the reproduction of bees such as cells, observation plates, or any other environment suitable for the reproduction of bees. To be more exact, the method provides to use a chemical composition comprising (±)-2-hydroxyhexanoic acid, (±)-3-hydroxyhexanoic acid, or a mixture thereof, which is able to attract the Varroa destructor mite and can thus be used to condition the behavior of the Varroa destructor mite in the beehive in order to prevent it from reproducing.

### BACKGROUND OF THE INVENTION

It is known that the Varroa destructor mite is a parasite on the domestic bee Apis mellifera that causes enormous damage to the bee colonies, so much so that, without a suitable protection treatment, the families of bees succumb in a short time to the action of this parasite.

Numerous acaricides are known in the struggle against this mite, including for example fluvalinate, flumethrin, acrinathrin, amitraz, coumaphos and other similar molecules.

Such acaricides, however, have the disadvantage that, since they have no specific action against the Varroa destructor mite, they can cause collateral damage to the bees; moreover, they have lost their effectiveness in many geographical areas, since many Varroa destructor populations have developed a resistance to one or more acaricides and can therefore continue to reproduce on the bees.

Another shortcoming of known acaricides is that they leave unwanted residues in the products of the bees such as the honey and the wax.

The accumulation of residues in the wax is worrying in that it is also used as a component in pharmaceutical and cosmetic creams and pomades and hence it must not have any unwanted residue of acaricide.

For these reasons, numerous studies have been carried out on substances known as semio-chemicals (chemical signals), involved in the life cycle of the Varroa destructor mite, in order to use them to modify the behavior thereof and to reduce the levels of infestation. These substances are present naturally in the beehive, they act in extremely low concentrations and are often volatile, so that the problem of residues does not exist.

In particular, great attention has been paid to the parasite's reproduction process, which occurs inside the cells containing the developing bee larva. The Varroa destructor mite enters the cell a few hours before opercolature and is induced, among other things, by chemical stimuli arriving from the cell itself. This behavior is exploited, in bee-keeping techniques, to capture part of the Varroa destructor mite on a honeycomb, called honeycomb trap, containing a clutch which, after opercolature, is removed from the nest and then destroyed, thus reducing the infestation; this intervention, however, has limited effectiveness and hence does not solve the problem.

The chemical stimuli involved in the entrance of the mite into the cell have been the object of numerous studies which have led to the identification of generic substances, such as methyl- and ethyl-esters of fatty acids, such as methyl palminate, aliphatic alcohols, saturated hydrocarbons with an odd number of carbon atoms, such as C₁₉-C₂₉, but in no case have the substances identified shown activity in the beehive, allowing to perfect devices to trap the mite.

Applicant has devised and embodied the present invention to overcome these shortcomings of the state of the art and to obtain other advantages.

### SUMMARY OF THE INVENTION

The present invention is set forth and characterized essentially in the main claims, while the dependent claims describe other innovative characteristics of the invention.

Purpose of the invention is to perfect a method by means of which it is possible to condition the behavior of the Varroa destructor mite in a beehive or in any other environment where bees reproduce, in order to prevent the clutch of bee larvae from being destroyed by the mite.

Another purpose of the present invention is to achieve a device that contains a semio-chemical substance active against the Varroa destructor mite, and that at the same time is able to release this substance slowly over time, in order to ensure a long-term protection of the beehive.

In accordance with these purposes, a method according to the present invention provides that a chemical composition comprising at least one of the following substances: (+)-2-hydroxyhexanoic acid, (−)-2-hydroxyhexanoic acid, (+)-3-hydroxyhexanoic acid, (−)-3-hydroxyhexanoic acid, or a mixture thereof, is applied in a determinate zone of a beehive or of means associated with the reproduction of bees, such as for example cells, observation plates, or any other environment suitable for the reproduction of bees, so as to attract the Varroa destructor mite therein.

It is known that these substances: (+)-2-hydroxyhexanoic acid and (−)-2-hydroxyhexanoic acid, and similarly (+)-3-hydroxyhexanoic acid and (−)-3-hydroxyhexanoic acid, are respectively optically active isomers. In the following description of the invention and of some preferential forms of embodiment of the invention, the two optical isomers (+)-2-hydroxyhexanoic acid or (−)-2-hydroxyhexanoic acid are grouped together for the sake of simplicity in the single expression “(±)-2-hydroxyhexanoic acid”, this expression meaning that, according to the invention, either one of the two individual isomers is used, or the racemic mixture of the two.

The expression “(±)-3-hydroxyhexanoic acid” will be used to indicate the use of one of the two single optical isomers, (+)-3-hydroxyhexanoic acid, or (−)-3-hydroxyhexanoic acid, or the use of the racemic mixture of the two.

To be more exact, (±)-2-hydroxyhexanoic acid and (±)-3-hydroxyhexanoic acid are attractive substances that attract the mite and are not toxic for the bees because they are contained in the food supplied to the bee larvae by the nursing bees.

By introducing an attractive substance into a beehive, or into the aforesaid artificial means, it is possible according to the invention to condition the behavior and the movement of the mite inside them, in order to prevent it from entering into the cells where there are the bee larvae. Advantageously the method provides that the chemical composition is first prepared by dissolving (±)-2-hydroxyhexanoic acid, or (±)-3-hydroxyhexanoic acid, or a mixture thereof, into a solvent, preferably water, or into other solvents such as esters of fatty acids, alcohols, or otherwise, able to facilitate the application thereof.

A preferential embodiment of the invention provides to prepare the chemical composition by means of one or more stabilizers able to protect in particular the hydroxyl group of (±)-2-hydroxyhexanoic acid, or of (±)-3-hydroxyhexanoic acid, and ensure that said acids, once applied in the beehive or in said means associated with the reproduction of the bees, do not deteriorate over time, because of contact with air or light.

In one embodiment of the invention, the chemical composition is dispersed, for example by means of a nebulizer, directly onto a portion of the clutch, so as to attract the Varroa destructor mite thereon. Subsequently, after opercolature, the portion of clutch is destroyed so as to completely eliminate the mite.

According to a variant, the chemical composition is applied directly in determinate areas of the beehive, or of said artificial means, which do not contain any clutches, so as to attract the Varroa destructor mite to areas not suitable for it to reproduce.

According to a variant, the chemical composition is applied not directly in said areas without clutches, but on predetermined small-size support means or artificial substrates, such as a plate, a disk, a panel, able to be arranged inside the beehive or inside said artificial means.

According to another variant, the method according to the present invention provides to saturate the area of the beehive by means of the chemical composition containing (±)-2-hydroxyhexanoic acid, (±)-3-hydroxyhexanoic acid, or a mixture thereof.

To be more exact, the method comprises a preparation step to prepare a device provided with containing means to contain the aforesaid chemical composition, and delivery means connected to the containing means and able to release (±)-2-hydroxyhexanoic acid, (±)-3-hydroxyhexanoic acid, or a mixture thereof, slowly over time. The device comprises for example a capsule, a wrapper, a container, a boat or a sponge and is inserted inside the beehive or between the artificial means.

The slow and constant release of (±)-2-hydroxyhexanoic acid or of (±)-3-hydroxyhexanoic acid or of both allows to confuse the Varroa destructor mite, interfering with its ability to identify the clutch suitable for reproduction.

According to another variant, the method according to the invention provides to introduce the composition containing (±)-2-hydroxyhexanoic acid, (±)-3-hydroxyhexanoic acid, or a mixture thereof, into the beehives or into the aforesaid artificial means during a period when the clutch is absent, for example in winter, so as to stimulate the Varroa destructor mite to search for the clutch to infest and thus begin its reproductive cycle during an unfavorable period, thus indirectly causing it to die.

### DESCRIPTION OF THE DRAWINGS

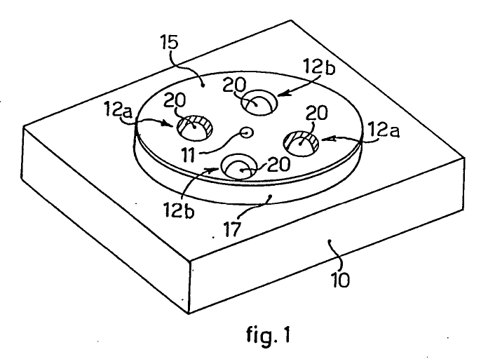

These and other characteristics of the present invention will become apparent from the following description of some activity tests of the aforesaid chemical composition and of some preferential forms of embodiment of the invention, given as a non-restrictive example. With reference to the attached drawing, FIG. 1 shows an artificial observation plate used to perform a biological activity test of (±)-2-hydroxyhexanoic acid and of (±)-3-hydroxyhexanoic acid. To be more exact, the activity tests were performed for the racemic mixtures of (±)-2-hydroxyhexanoic acid and of (±)-3-hydroxyhexanoic acid.

### Activity test of (±)-2-hydroxyhexanoic acid of (±)-3-hydroxyhexanoic acid in artificial observation plates

To perfect the method according to the present invention an activity test was made of (±)-2-hydroxyhexanoic acid and of (±)-3-hydroxyhexanoic acid in the laboratory, in artificial observation plates. (±)-2-hydroxyhexanoic acid was tested in a beehive too, as will be described hereafter.

By means of this activity test it is proved that said acids are naturally present in the food supplied to the bee larvae by the nursing bees and contained in the cells. To be more exact, said acids were extracted in acetone to isolate them from the rest of the larva food and were then tested according to the biological test described hereafter.

The activity of (±)-2-hydroxyhexanoic acid and of (±)-3-hydroxyhexanoic acid, dissolved in water, was tested in a plate 10 (FIG. 1). Each plate 10 consists of a parallelepiped of sodium-calcium glass with a 70×70 mm square base, and a height of 12 mm, in which four cylindrical wells 12a, 12b, are made, each with a diameter of 7 mm and a depth of 10 mm, similar in size to bee cells. The wells 12a, 12b are equidistant from the center. At the center of the plate 10 a Varroa destructor mite was placed, indicated by the number 11.

To delimit the space in which the mite 11 could move, the plates 10 were closed with a cover element 15 consisting of a glass disk joined to a stainless steel spacer ring 17. Two opposite wells 12a of each plate 10 were treated with (±)-2-hydroxyhexanoic acid or with (±)-3-hydroxyhexanoic acid, dissolved in water; the other two wells 12b, on the contrary, were used as controls and were treated only with the solvent. In each individual well 12a, 12b of the plate 10 a bee larva 20 was then placed.

The biological activity test on (±)-2-hydroxyhexanoic acid provides a first test during which 1 ng of (±)-2-hydroxyhexanoic acid is tested, a second test during which 10 ng of (±)-2-hydroxyhexanoic acid are tested and a third test during which 100 ng are tested and a fourth test during which 1000 ng are tested.

The biological activity test on (±)-3-hydroxyhexanoic acid provides a first test during which 10 ng of (±)-3-hydroxyhexanoic acid are tested, a second test during which 100 ng of (±)-3-hydroxyhexanoic acid are tested, and a third test during which 1000 ng are tested.

At the beginning of each test the Varroa destructor mite 11, in this case a female adult, is located at the center of each plate 10 with a thin brush; each plate 10 is then closed and transferred to a thermostatic chamber. Subsequently, the position of the mite 11 was monitored every 5 minutes for a total of 30 minutes, to a total of 6 observations.

20 plates were used for every test, with 4 repetitions, to a total of 80 plates. During the tests the temperature and relative humidity were kept respectively around 34° C. and 75%; the inside of the thermostatic chamber was kept dark.

The action of the substances tested on the Varroa destructor mite was evaluated by calculating an average value for the treated wells 12a and the control wells 12b, equal to the average number of times in which the Varroa destructor mite was observed inside one or the other in the 6 observations made in the course of the 30 minutes of each test. The average values thus obtained are representative, with a certain approximation, of the time spent by the mite in the two types of well 12a, 12b. The attractiveness of a substance thus determines higher average values for the treated wells 12a with respect to those of the control wells 12b. It must be pointed out that, for every test, the sum of the average values of the treated wells 12a and of the control wells 12b does not reach a total of 100% because a fraction, more or less great, of the mites spends part of the time outside the wells 12a, 12b.

(±)-2-hydroxyhexanoic acid was found to be active on and attractive to the Varroa destructor mite at doses of 10 and 100 ng, since it determined a significantly greater infestation of the treated wells 12a with respect to the control wells 12b.

(±)-3-hydroxyhexanoic acid was found to be active on and attractive to the Varroa destructor mite at the dose of 100 ng, since it determined a significantly greater infestation of the treated wells 12a with respect to the control wells 12b.

### Comparative Test

Other substances naturally present in the food supplied to bee larvae by the nursing bees, identified by extracting and isolating them from the larva food, were also tested by means of the activity test.

To be more exact, the activity test was done at least three times with 100 ng of each of the following substances: hexanoic acid, octanoic acid, nonanoic acid, phenylacetic acid, benzoic acid, (Z)-3-hexanoic acid, (E)-3-hexanoic acid, 2-methylbutanoic acid, 3-methylbutanoic acid, 3-methylpentanoic acid and 2-ethylhexanoic acid.

To give an example, we report the results of the comparative test obtained with (±)-2-hydroxyoctanoic acid which has a very similar structure to (±)-2-hydroxyhexanoic acid. 100 ng of (±)-2-hydroxyoctanoic acid were tested with respect to the control and this acid was not found to be active.

The results of the activity test of (±)-2-hydroxyhexanoic acid and of (±)-3-hydroxyhexanoic acid and of the comparative test are reported in Table 1; to be more exact, the activities of (+)-2-hydroxyhexanoic acid and of (±)-3-hydroxyhexanoic acid at different doses were compared with each other and with (±)-2-hydroxyoctanoic acid.

TABLE 1
Result of some laboratory tests with substances
identified in the larva food.

| | AVERAGE | SIGNIFI- | |
|---|---|---|---|
| | ACTIVITY | CANCE | |
| ACTIVE PRINCIPLE | TREATED | CONTROL | |
| (±)-2-hydroxyhexanoic | 22.3 | 23.5 | — |
| acid, 1 ng | | | |
| (±)-2-hydroxyhexanoic | 31.8 | 17.8 | P < 1% |
| acid, 10 ng | | | |
| (±)-2-hydroxyhexanoic | 34.7 | 21.1 | P < 1% |
| acid, 100 ng | | | |
| (±)-2-hydroxyhexanoic | 23.0 | 26.0 | — |
| acid, 1000 ng | | | |
| (±)-3-hydroxyhexanoic | 24.5 | 21.8 | — |
| acid, 10 ng | | | |
| (±)-3-hydroxyhexanoic | 36.8 | 22.8 | P < 1% |
| acid, 100 ng | | | |
| (±)-3-hydroxyhexanoic | 23.3 | 22.5 | — |
| acid, 1000 ng | | | |
| (±)-2-hydroxyoctanoic | 29.5 | 29.5 | — |
| acid, 100 ng | | | |

### Activity test of (±)-2-Hydroxyhexanoic acid in the beehive

(±)-2-hydroxyhexanoic acid was also tested in the beehive, by applying, in the cells with worker bee larvae near to opercolature, a solution of 100 ng of (±)-2-hydroxyhexanoic acid dissolved in 1 μl of a suitable solvent. The infestation of such cells was compared with that of the control cells treated with the solvent alone: the cells used were examined 18 hours after treatment and the Varroa destructor mites present in the treated cells and in the control cells were counted.

The number of Varroa destructor mites per cell in the cells treated with (±)-2-hydroxyhexanoic acid was significantly greater than that found in the non-treated cells.

This means that (±)-2-hydroxyhexanoic acid modifies and conditions the behavior of the Varroa destructor mite in the beehive too.

TABLE 2
Result of the tests carried out in the beehive
with (±)-2-hydroxyhexanoic acid

| | | N. OF VARROA | |
|---|---|---|---|
| | | DESTRUCTOR MITE | |
| | N. OF CELLS | PER CELL | |
| REPLICATION | TREATED | TREATED | CONTROL |
| 1 | 225 | 0.27 | 0.22 |
| 2 | 265 | 0.32 | 0.23 |
| 3 | 180 | 0.30 | 0.26 |
| 4 | 169 | 1.38 | 0.72 |
| 5 | 140 | 0.73 | 0.70 |
| Average | | 0.60 | 0.43 |

### DETAILED DESCRIPTION OF SOME PREFERENTIAL FORMS OF EMBODIMENT OF THE INVENTION

According to a first form of embodiment, the method according to the present invention provides a first step wherein a chemical composition C1 is prepared with a concentration of about 0.100 g/l of (±)-2-hydroxyhexanoic acid, or of (±)-3-hydroxyhexanoic acid, or a mixture thereof, in water.

In a second step, 1 μl of the composition C1 is injected into each cell of a group of cells of a beehive with worker bee larvae near to opercolature. In this way we obtain a group of cells, the so-called treated cells, which attract the Varroa destructor mites.

After opercolature, the group of treated cells is extracted from the beehive and destroyed, so that the Varroa destructor mites are also destroyed with it.

According to another form of embodiment, the method according to the present invention provides a first step wherein a chemical composition C1 is prepared with a concentration of about 0.100 g/l of (±)-2-hydroxyhexanoic acid or (±)-3-hydroxyhexanoic acid or a mixture thereof, dissolved in water.

In a second step, the composition C1 is nebulized onto a group of cells in a beehive with worker bee larvae near to opercolture. In this way we obtain a group of cells, the so-called treated cells, which attract the Varroa destructor mites.

After opercolature, the group of treated cells is extracted from the beehive and destroyed, so that the Varroa destructor mites are also destroyed with it.

According to another form of embodiment of the invention, the method provides to prepare a chemical composition C2 containing (±)-2-hydroxyhexanoic acid or (±)-3-hydroxyhexanoic acid or a mixture thereof, with an overall dose of about 10 mg, and other compounds including stabilizers of a known type, which ensure the protection of the hydroxyl group and the conservation of the acids over time.

The chemical composition C2 is then inserted in a delivery device such as, for example, a capsule of a known type, which is subsequently positioned inside the beehive in order to release (±)-2-hydroxyhexanoic acid and/or (±)-3-hydroxyhexanoic acid slowly and progressively throughout the environment.

Diffused (±)-2-hydroxyhexanoic acid and/or diffused (±)-3-hydroxyhexanoic acid confuse the Varroa destructor mite so as to prevent it from identifying the clutch of bee larvae, so that it can no longer reproduce.

Therefore, the use of one of the following substances: (+)-2-hydroxyhexanoic acid, (−)-2-hydroxyhexanoic acid, (+)-3-hydroxyhexanoic acid, (−)-3-hydroxyhexanoic acid, or of a mixture thereof, is able to condition and control the behavior and the movement of the Varroa destructor mite in a beehive or in artificial means associated with the reproduction of bees.

It is clear, however, that modifications and/or additions of parts can be made to the method as described heretofore without departing from the field and scope of the present invention.

1. Method to control and condition the behavior of the Varroa destructor mite in a beehive, or in artificial means associated with the reproduction of bees, comprising a step of applying, in said beehive, or in said artificial means, a chemical composition comprising a substance selected from the group consisting of: (+)-2-hydroxyhexanoic acid, (−)-2-hydroxyhexanoic acid, (+)-3-hydroxyhexanoic acid, (−)-3-hydroxyhexanoic acid, of and a mixture thereof.

2. Method as in claim 1, wherein said chemical composition is dispersed on a portion of a clutch in said beehive, or in said artificial means, so as to attract thereon the Varroa destructor mite.

3. Method as in claim 2, wherein said portion of said clutch, after an opercolature step, is destroyed so as to eliminate the Varroa destructor mite.

4. Method as in claim 1, wherein said chemical composition is applied directly in determinate areas of said beehive, or of said artificial means, where there is no clutch of bee larvae, so as to attract the Varroa destructor mite to zones not suitable for the mite to reproduce.

5. Method as in claim 1, wherein said chemical composition is applied on substrates or artificial support means, which are then arranged in determinate areas of said beehive, or of said artificial means, where there is no clutch of bee larvae, so as to attract the Varroa destructor mite to zones not suitable for the mite to reproduce.

6. Method as in claim 1, wherein said chemical composition is applied in zones of said beehive, or of said artificial means, without a clutch, so as to stimulate the Varroa destructor mite to begin its reproductive phase during an unfavorable period and thus indirectly causing the mite to die.

7. Method as in claim 1, comprising a saturation step of said beehive, or of said artificial means, during which said chemical composition is dispersed in random manner so as to confuse the Varroa destructor mite, interfering with ability of the mite to identify a clutch of bee larvae.

8. Method as in claim 1, comprising a first preparation step to prepare said chemical composition wherein stabilizing compounds are added to one or more of the following substances: (+)-2-hydroxyhexanoic acid, (−)-2-hydroxyhexanoic acid, (+)-3-hydroxyhexanoic acid, (−)-3-hydroxyhexanoic acid.

9. Device for the application of a chemical composition in a beehive, or in artificial means associated with the reproduction of bees, to condition the behavior of the Varroa destructor mite, comprising containing means to contain a chemical composition comprising a substance selected from the group consisting of: (+)-2-hydroxyhexanoic acid, (−)-2-hydroxyhexanoic acid, (+)-3-hydroxyhexanoic acid, (−)-3-hydroxyhexanoic acid, and a mixture thereof, and delivery means connected to said containing means and able to deliver one of said substances or the mixture thereof.

10. Device as in claim 9, wherein said containing means and delivery means comprise a capsule, a container, a boat or a spongy element able to progressively release over time at least one of said substances or the mixture thereof.

11. Device as in claim 9, wherein said containing means also contain stabilizing substances able to protect said (+)-2-hydroxyhexanoic acid, said (−)-2hydroxyhexanoic acid, said (+)-3-hydroxyhexanoic acid, or said (−)-3-hydroxyhexanoic acid, from the degradation which can occur in contact with air, or due to exposure to light.

12. A method of use of a substance selected from the group consisting of: (+)-2-hydroxyhexanoic acid, (−)-2-hydroxyhexanoic acid, (+)-3- hydroxyhexanoic acid, (−)-3-hydroxyhexanoic acid, and a mixture thereof, in order to condition and control the behavior and the movement of the Varroa destructor mite in a beehive or in artificial means associated with the reproduction of bees comprising depositing the substance at a location to cause the mite to be attracted to the location.
